(19) United States
(12) Patent Application Publication
(10) Pub. No.: US 2008/0264651 A1
(43) Pub. Date: Oct. 30, 2008

(54) ELECTRICAL PUMP POWER CABLE MANAGEMENT

(75) Inventors: Mohammad Athar Ali, Al-Khobar (SA); Donald W. Ross, Houston, TX (US)

Correspondence Address: SCHLUMBERGER RESERVOIR COMPLETIONS, 14910 AIRLINE ROAD, ROSHARON, TX, 77583, US

(73) Assignee: SCHLUMBERGER TECHNOLOGY CORPORATION, Sugar Land, TX (US)

(21) Appl. No.: 11/774,128

(22) Filed: Jul. 6, 2007

Related U.S. Application Data
(60) Provisional application No. 60/914,982, filed on Apr. 30, 2007.

(51) Int. Cl. E21B 19/00; H02G 3/00

(52) U.S. Cl. 166/385; 166/242.2; 174/100

(57) ABSTRACT

A technique for deploying a communication line in a tubing used in a wellbore. The communication line is positioned within the tubing which may be used to deploy a well device into a wellbore. Additionally, a reactive material is placed into the tubing. The consistency of the reactive material may be selectively changed so as to fill space between the cable and the tubing, thus providing support for the cable and/or pressure isolation along the tubing.

### CROSS-REFERENCE TO RELATED APPLICATION

The present document is based on and claims priority to U.S. Provisional Application Ser. No. 60/914,982, filed Apr. 30, 2007.

### BACKGROUND

An electric submersible pump may be suspended in a well from coiled tubing with an electric cable inside the coiled tubing to provide power to the pump motor. Produced fluid is pumped up the casing along the coiled tubing annulus. Generally, electrical power cables and other cables have low tensile strength, and the length of power cable that can be freely suspended in inclined tubing is limited. Therefore, the cable may be clamped, banded or strapped to the outside of the tubing at intervals. An alternative approach routes the cable within the coiled tubing.

Systems have been developed to support the electric power cable inside coiled tubing for electric submersible pumping system applications. For example, some systems employ anchor devices spaced along the cable to frictionally restrain the cable along the tubing. In other systems, “dimples” are provided along the coiled tubing wall to mechanically support the cable. In other systems, the cable is bonded to the tubing bore during manufacture of the tubing. Attempts also have been made to use a viscous fluid inside the coiled tubing to suspend the cable, while other systems have used a dense fluid inside the coiled tubing to float the cable.

Still other systems support the power cable within the coiled tubing by utilizing helical buckling of the cable to frictionally restrain the cable relative to the inside wall of the tubing. In one example, the power cable is generally in tension when assembled at the surface, and additional cable is fed into the conduit, e.g. coiled tubing, after the conduit is suspended in the well. Such a procedure, however, results in an assembly in which the bottom of the cable is heavily buckled while the upper portion of the cable is in tension. When additional cable is fed into the conduit, some buckling does occur at the upper end of the conduit, but this buckling may generally be loose. Additionally, at the mid-portion of the conduit, the cable may remain in tension and thus not buckle. As a result, the system does not produce a uniform buckling along the length of the assembly, and vibration of the assembly during use can reduce the anchoring friction below a critical threshold and also cause the cable to progressively settle until a stable, tighter helix is formed. This situation can cause a pull-off of the cable connector or other failure.

To some extent, cable slippage can be compensated by providing excess cable in the wellhead. However, providing excess cable in the wellhead requires a special tree design and generally does not allow easy access for deployment and removal of the tubing and electric submersible pumping system under pressure. Additionally, leakage along the interior of the conduit can allow pressure to migrate between the tubing and the cable and into the wellhead. This creates greater difficulty in providing well control and potentially requires removal of the tubing and electric submersible pumping system under pressure. Furthermore, if a solid tubing hangar is used to prevent the migration of pressure, there is no space for providing excess cable. Any slippage of cable can then cause cable failure.

### SUMMARY

In general, the present invention provides a method and system for deploying a communication line in a tubing used in a wellbore. The communication line, e.g. cable, is deployed within the tubing which may be connected to a well device designed for deployment in a wellbore. Additionally, a reactive material is placed into the tubing. The consistency of the reactive material may be selectively changed so as to fill space between the cable and the tubing, thus providing support for the cable and/or pressure isolation along the tubing.

### BRIEF DESCRIPTION OF THE DRAWINGS

Certain embodiments of the invention will hereafter be described with reference to the accompanying drawings, wherein like reference numerals denote like elements, and:

FIG. 1 is a front elevation view of a well device deployed on tubing in a wellbore, according to an embodiment of the present invention;

FIG. 2 is an orthogonal view of a section of tubing having an internal communication line and filler material, according to an embodiment of the present invention;

FIG. 3 is a flowchart illustrating a procedure for supporting a communication line and/or creating a pressure barrier in the tubing, according to an embodiment of the present invention;

FIG. 4 is a flowchart illustrating an alternate procedure for supporting a communication line and/or creating a pressure barrier in the tubing, according to an embodiment of the present invention; and

FIG. 5 is a view of an assembly for deploying coiled tubing and internal communication line in a wellbore, according to an embodiment of the present invention.

### DETAILED DESCRIPTION

In the following description, numerous details are set forth to provide an understanding of the present invention. However, it will be understood by those of ordinary skill in the art that the present invention may be practiced without these details and that numerous variations or modifications from the described embodiments may be possible.

The present invention generally relates to a technique for supporting a communication line in a tubing and/or for preventing migration of fluid and pressure along the tubing. The technique comprises systems and methods for installing electrical power cable or other types of communication line into tubing at a surface location. The tubing is used for deploying and suspending a well device, such as an electric submersible pumping system, in a well. The technique enables the use of, for example, a solid coiled tubing hangar by supporting the internal communication line against slippage.

For the purpose of explanation, the methods and components described herein often relate to suspending an electric submersible pumping system on tubing within a wellbore. However, it should be understood that the tubing may comprise a variety of conduits, tubes or pipes, e.g. coiled tubing, jointed tubing and the like, used to suspend a variety of wellbore equipment in a wellbore. By way of example, pumping systems, logging tools, wireline tools, drilling tools, and other types of well devices can be deployed within a wellbore on the tubing. Additionally, a communication line is routed through the tubing and often comprises an electric power cable used in communicating power signals between a surface location and the downhole wellbore device. However, the communication line may comprise other types of communication lines, including a variety of cables, tubes, conduits, wires, optical lines, and other types of power and/or data communication lines.

The installation of an electric submersible pumping system or other well device in a wellbore with power cable inside a tubing poses a challenge of managing cable inside the tubing. The system and methodology described herein substantially eliminate slippage of the communication line by the presence of a void-filling material inside the tubing. The material fills the empty void between the communication line and the tubing. In some embodiments, the void-filling material is a reactive material that may be introduced into the tubing via, for example, pumping and allowed to change consistency, e.g. cure or set, thus removing space inside the tubing and preventing the communication line from slipping. Among other benefits, this enables the use of a solid tubing hangar able to prevent fluid flow into the wellhead.

The void-filling material also provides a pressure barrier in case of a leak within the tubing. Examples of suitable void-filling materials include a variety of reactive materials, such as liquid hydro-gel and hardfoam which is available under the trade name Bacel® from GroundSafe. In some embodiments, the void-filling material is hydrocarbon resistant or otherwise resistant to well contaminants that may leak into the tubing. A variety of foamable materials, gel materials and other reactive materials can be used to meet the requirements of a given working environment with respect to, for example, well temperature, pressure, presence of hydrogen sulfide, presence of carbon dioxide and other factors. Depending on the application, the material also can be selected to facilitate communication line, e.g. power cable, installation and introduction of the reactive material by a suitable procedure, such as pumping. In other applications, the reactive material may be selected so that the communication line can be completely or partially covered or wrapped in the material. By way of example, the communication line can be wrapped in a swellable material, e.g. a swellable hydro-gel material or a hydrocarbon swellable rubber that swells upon contact with a hydrocarbon agent. After installing the wrapped power cable inside the tubing, a reactive agent is introduced into the tubing to cause the swellable material to swell. This enables the swellable material to fill the gap between the communication line and the tubing, thereby limiting cable slippage and achieving a pressure barrier in the tubing.

The use of the void-filling material provides a communication line management technique that enables the termination of tubing inside the wellhead at the hanger with a standard electrical and mechanical connector. The wellhead does not require a special design to accommodate excess communication line inside the wellhead. The use of a standard wellhead further allows the removal of the tubing and electric submersible pumping system under pressure if such a removal approach is required.

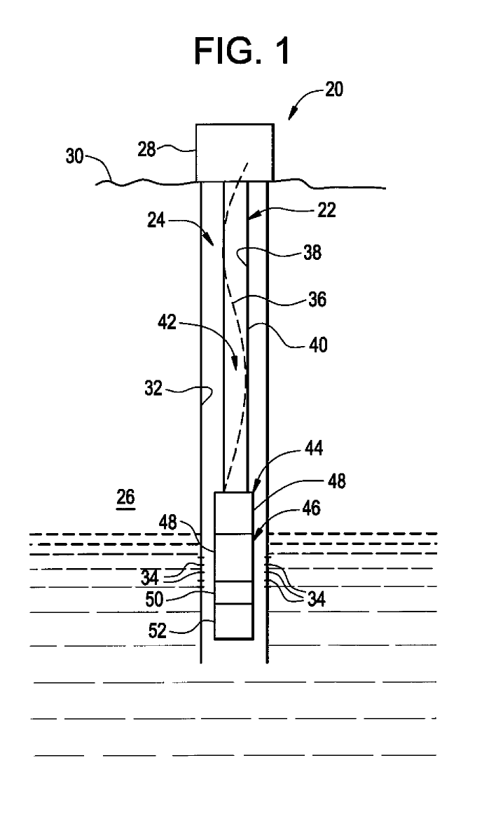

Referring generally to FIG. 1, one example of a system utilizing the cable management technique is illustrated. In this embodiment, a well system 20 comprises a communication line management system 22 deployed in a wellbore 24. The wellbore 24 is drilled into a geological formation 26 and extends downwardly from a wellhead 28 positioned at a surface 30, such as a seabed floor or a surface of the earth. The wellbore 24 may be oriented generally vertically or with combined vertical and deviated sections. Furthermore, the wellbore 24 may be open or lined with a casing 32 depending on the specific environment and application. If wellbore 24 is lined with casing 32, a plurality of perforations 34 are formed through the casing to accommodate flow of fluid between formation 26 and wellbore 24.

In the embodiment illustrated, communication line management system 22 comprises a communication line 36 routed along an interior 38 of a tubing 40. As discussed above, communication line 36 may comprise a power cable for communicating power signals, or it may comprise a variety of other communication lines that can be used, for example, to communicate data uphole and/or downhole. Examples of communication lines comprise electrical lines, hydraulic tubing, optical fibers, and other communication lines as well as combinations of those lines. Furthermore, tubing 40 may comprise coiled tubing, but the tubing also may be formed of jointed tubing or other types of conduits and tubes that can be utilized in a wellbore environment.

Communication line 36 is supported in tubing 40 by a void-filling material 42 that can be introduced into an interior 38 as a fluid via, for example, pumping. However, other types of void-filling materials can be introduced into the interior 38. The void-filling material 42 is used to support communication line 36 and/or to create a pressure barrier within tubing 40. By way of example, communication line 36 can be pulled into tubing 40, e.g. coiled tubing, by a wire previously pumped through the tubing using a pig. Once the communication line 36 is within tubing 40, the void-filling material 42 can be pumped into the tubing. The communication line 36 can be pulled through the coiled tubing while the coiled tubing is unspooled along a surface location. However, other methods can be used to introduce both the communication line 36 and the void-filling material 42 into tubing 40.

In the embodiment illustrated, tubing 40 also is utilized in deploying a well device 44 into wellbore 24. For example, well device 44 may comprise an electric submersible pumping system 46 coupled to a lower end of tubing 40 via a connector 48. The electric submersible pumping system 46 may comprise a variety of components depending on the specific pumping application. By way of example, electric submersible pumping system 46 comprises a submersible pump 48, a motor protector 50, and a submersible motor 52 that drives submersible pump 48. In this type of embodiment, communication line 36 often comprises a power cable routed to electric submersible pumping system 36 to provide electrical power to submersible motor 52.

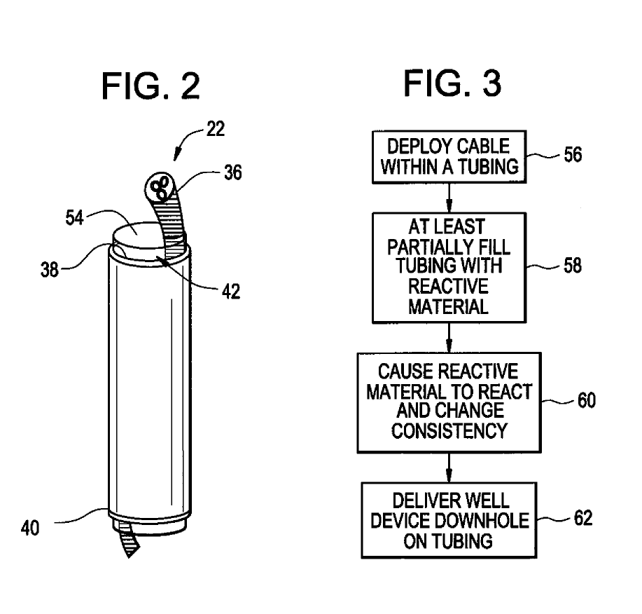

As further illustrated in FIG. 2, void-filling material 42 may comprise a reactive material 54 initially deployed within the interior 38 of tubing 40. The reactive material 54 may be introduced into tubing 40 prior to deployment of well device 44 into wellbore 24 or after deployment of the well device, depending on the specific type of reactive material utilized as well as the type of well application. For example, the stage at which reactive material 54 is introduced may vary depending on the properties of the material. The reactive material 54 may comprise a foamable material, a gel material, a swellable material, and other materials that are selectively transformed from one consistency to another. By way of example, a foamable material or a gel material can be introduced into interior 38 in liquid form and transitioned to a solid or semi-solid material able to support communication line 36 and/or create a pressure barrier along the interior of tubing 40. The reaction causing material 54 to transition from one consistency to another can be caused by a variety of agents, depending on the characteristics of the reactive material 54. For example, the transition can be caused by introduction of a reactive agent, such as a catalyst, a change in pressure, a change in temperature, the provision of sufficient time to enable curing/setting of the material, or other agents, i.e. factors, able to induce the desired transition in the material.

One example of a methodology for managing the communication line is illustrated by the flowchart of FIG. 3. In this embodiment, a cable, e.g. a power cable, requires support within a tubing, e.g. coiled tubing, used to deploy well device 44. Initially, the cable is deployed within the tubing 40, as illustrated by block 56 in FIG. 3. The tubing 40 is then at least partially filled with reactive material 54, as illustrated by block 58. By way of example, the reactive material may be in fluid form and pumped into interior 38. A suitable agent is then provided to cause reactive material 54 to react and change consistency, as illustrated by block 60. After undergoing this transition in consistency, reactive material 54 is converted to void-filling material 42 to provide both support for the cable and a pressure barrier along the interior of tubing 40. The well device 44 can then be delivered downhole on tubing 40, as illustrated by block 62. It should be noted that in other applications, well device 44 can be delivered downhole prior to introduction of the reactive material 54 into tubing 40 or prior to causing the reactive material to change consistency.

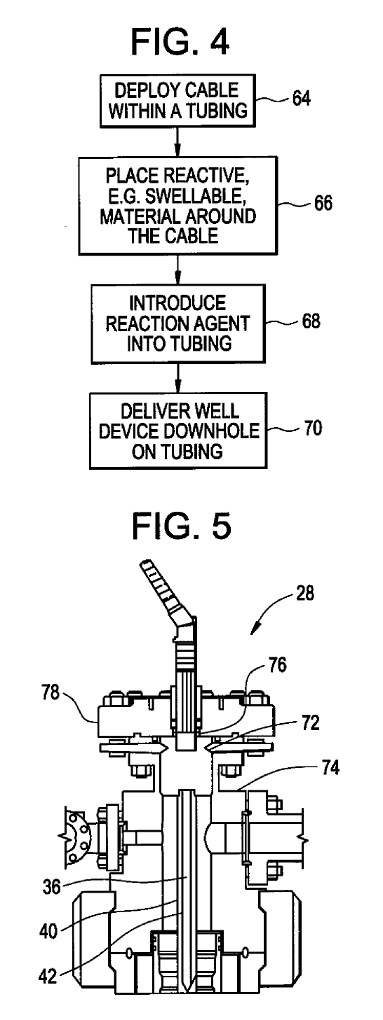

A variation of the methodology embodiment illustrated in FIG. 3 involves placing the reactive material around the cable or other type of communication line, as illustrated by the flowchart of FIG. 4. In this embodiment, the cable is again deployed within tubing 40, as illustrated by block 64 of FIG. 4. However, during, prior, or after deployment of the cable within tubing 40, a reactive material 54 is placed around the cable, as illustrated by block 66. For example, a swellable material, such as a swellable hydro-gel, can be wrapped around the cable as it is delivered into tubing 40. Once the reactive material 54 is positioned around the cable and deployed within tubing 40, a suitable reaction agent is introduced to interior 38 of tubing 40, as illustrated by block 68. The reaction agent causes reactive material 54 to sufficiently swell or otherwise change consistency in a manner that fills the voids between the cable and tubing 40 so as to provide support for the cable and/or a pressure seal within tubing 40. The well device 44 can then be delivered downhole on tubing 40, as illustrated by block 70. Again, it should be noted that in other applications, well device 44 can be delivered downhole at an earlier stage, such as prior to introduction of the reaction agent into tubing 40.

The use of void-filling material 42 also enables the use of a wellhead 28 that does not require special structures to store excess cable. As mentioned previously, use of a solid coiled tubing hangar is enabled through the use of void-filling material 42 to support the cable. One embodiment of wellhead 28 is illustrated in FIG. 5. In this embodiment, wellhead 28 is designed to deliver coiled tubing 40 and internal communication line 36 into wellbore 24. The wellhead 28 may comprise a solid coiled tubing hangar 72 within a coiled tubing head assembly 74. The solid coiled tubing hangar 72 prevents any upward migration of pressure even in the event of a coiled tubing leak. Furthermore, signal communications can be established with communication line/cable 36 through the tubing hangar 72 via an appropriate penetrator 76 once top flange 78 is mounted to head assembly 74. The wellhead 28 need not be uniquely configured to provide a storage area for excess cable. During the entire well operation, e.g. a production operation, the void-filling material 42 supports the cable without slippage.

Void-filling material 42 can be used in many well related applications. For example, the material can be used to support a variety of communication lines and production applications, well treatment applications, well testing applications, and other well related applications that utilize a tubing to deploy a well device in combination with a line for communicating signals, e.g. power signals or data signals. Additionally, the system can utilize a variety of well devices, including production devices, e.g. electric submersible pumping system 46, well service devices, well testing devices and other devices.

Accordingly, although only a few embodiments of the present invention have been described in detail above, those of ordinary skill in the art will readily appreciate that many modifications are possible without materially departing from the teachings of this invention. Such modifications are intended to be included within the scope of this invention as defined in the claims.

What is claimed is:

1. A method of supporting a cable in a wellbore, comprising:
deploying a cable within a tubing;
connecting a well device to the tubing;
placing a reactive material within the tubing; and
supporting the cable in the tubing by causing the reactive material to react and sufficiently fill the space around the cable to support the cable.

2. The method as recited in claim 1, wherein deploying comprises deploying a power cable to communicate power downhole.

3. The method as recited in claim 1, wherein deploying comprises deploying a data signal cable.

4. The method as recited in claim 1, wherein deploying comprises deploying the cable within coiled tubing.

5. The method as recited in claim 1, wherein connecting comprises connecting an electric submersible pumping system to the tubing.

6. The method as recited in claim 1, wherein placing comprises using the reactive material in the form of a curable material.

7. The method as recited in claim 1, wherein placing comprises using the reactive material in the form of a foam forming material.

8. The method as recited in claim 1, wherein placing comprises using the reactive material in the form of a liquid hydro-gel.

9. The method as recited in claim 1, wherein placing comprises using the reactive material in the form of a swellable material, and wherein supporting comprises introducing a reactive material into the tubing to cause the swellable material to swell.

10. A method, comprising:
deploying a communication line in a tubing used in a wellbore;
placing a fluid material into the tubing; and
causing the fluid material to set sufficiently to support the communication line in the tubing when the tubing is positioned in the wellbore.

11. The method as recited in claim 10, wherein deploying comprises deploying a cable in the tubing.

12. The method as recited in claim 10, wherein placing comprises placing a liquid hydro-gel into the tubing.

13. The method as recited in claim 10, wherein placing comprises placing a foamable material into the tubing.

14. The method as recited in claim 10, wherein placing comprises placing a swellable material into the tubing.

15. The method as recited in claim 10, wherein causing comprises introducing a second fluid into the tubing.

16. The method as recited in claim 10, wherein causing further comprises establishing a pressure barrier within the tubing when the fluid material is set.

17. The method as recited in claim 10, further comprising delivering a well device downhole on the tubing.

18. A method, comprising:
placing a communication line within a tubing;
connecting a well device to the tubing for delivery into a wellbore;
introducing a reactive material into at least a portion of the tubing; and
causing the reactive material to undergo a reaction that sufficiently changes the consistency of the reactive material to create a pressure barrier in the tubing around the communication line.

19. The method as recited in claim 18, wherein placing comprises placing the communication line within coiled tubing.

20. The method as recited in claim 18, wherein connecting comprises connecting an electric submersible pumping system to the tubing.

21. A well system, comprising:
a communication line within a tubing; and
a reactive material within the tubing, wherein the consistency of the reactive material may be selectively changed from a non-supporting material to a supporting material able to support the communication line within the tubing when the tubing is positioned in a wellbore.

22. The well system as recited in claim 21, wherein the tubing comprises coiled tubing.

23. The well system as recited in claim 21, wherein the communication line comprises a communication cable.

24. The well system as recited in claim 21, wherein the reactive material comprises a foamable material.

25. The well system as recited in claim 21, wherein the reactive material comprises at least one selected from the following: a gel material and a swellable material.

26. (canceled)
